(19) United States
(12) Patent Application Publication
(10) Pub. No.: US 2014/0259003 A1
(43) Pub. Date: Sep. 11, 2014

(54) METHOD FOR TRUSTED APPLICATION DEPLOYMENT

(71) Applicant: GO DADDY OPERATING COMPANY, LLC, Scottsdale, AZ (US)

(72) Inventors: Ganesh Devarajan, Phoenix, AZ (US); David Wootan, Scottsdale, AZ (US); Todd Redfoot, Phoenix, AZ (US); Michol Murray, Chandler, AZ (US)

(73) Assignee: Go Daddy Operating Company, LLC, Scottsdale, AZ (US)

(21) Appl. No.: 13/789,357

(22) Filed: Mar. 7, 2013

(51) Int. Cl. G06F 9/445

(52) U.S. Cl. CPC G06F 8/65
USPC 717/172

(57) ABSTRACT

A system and method for verifying content distributed by a distributed authority system over a communications network are presented. In step a) software content is requested from a distribution center communicatively coupled to the communications network, and in step b) a package is received from the distribution center. The package includes at least a manifest and the software content. In step c) at least one certificate is accessed to analyze the package to verify a chain of certificates associated with the package back to an intermediary root certificate, and in step d) at least one of the manifest and the software content is analyzed to verify the package as corresponding to the software content requested from the distribution center. In step e), if step c) or step d) fail to verify, processing of the software package is discontinued, otherwise access to the software content is permitted.

### CROSS-REFERENCE TO RELATED APPLICATIONS

This application is related to U.S. patent application Ser. No. ______, filed on ______, and entitled “SYSTEM FOR TRUSTED APPLICATION DEPLOYMENT.”

### BACKGROUND OF THE INVENTION

At an ever increasing rate, modern technology is transforming devices that were individualized or generally autonomous into devices that are designed for two-way communication over a communications network. For example, so-called set-top boxes used by media-delivery companies have evolved from being static content portals that communicate unidirectionally from the media company's system to the user of the set-top box into dynamic, interactive, content communications devices that facilitate two-way communication between various entities and the end user.

In the above example, a “network” or “communications network” is a broad term that generally refers to a collection of links and nodes (e.g., computing devices and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between users. Hundreds of millions of people around the world have access to computers connected to the Internet via Internet Service Providers (ISPs). Content providers distribute content, such as multimedia information, including text, graphics, audio, video, animations, and other forms of data to consumers using the Internet. In addition, businesses utilize the Internet to facilitate business transactions and communicate between buyers and sellers, suppliers and customers, and many other entities.

Along with the trend of moving more and more devices onto communications networks and facilitating two-way communications there over, many of these same and other devices are being designed with increasingly flexible software. In fact, many of these devices are being developed to act as platforms for future development of and changes to software associated with the device. For example, cellular phones have evolved from devices with static firmware and software features tightly integrated therewith to general mobile computing devices that serve as a platform upon which a multi-billion dollar software industry has been built.

With the movement toward ubiquitous connection to communications networks by an increasingly diverse range of devices and the trend of designing devices to evolve with regular software updates or to act as a platform for developers, the end user is empowered to enjoy new and exciting functionality that was not possible with traditional devices. The user can often select and add new functionality to devices by downloading new software directly to a given device over a communications network and realize capabilities not possible when the user originally purchased the device. Thus, to the user, the value associated with the device is typically increased with some regularity.

Unfortunately, empowering the end user by providing access to communications networks and/or with user-selectable software updates or additions comes at a cost. For example, it is widely appreciated that the advantages of connecting devices to communications network comes at a cost of increased potential for security risks. Furthermore, the ability to change or add software to a device presents the potential for software conflicts and presents a further security risk.

Therefore, it would be desirable to have a system and method for managing the risks associated with devices being connected to communications networks and having user-controlled software and software updates.

### BRIEF DESCRIPTION OF THE DRAWINGS

FIGS. 1A and 1B are a schematic block diagram of a payment card industry operating hierarchy and operating environment.

FIG. 2 is a data flow diagram pertaining to a process for certificate issuance.

FIG. 3 is a schematic block diagram illustrating an exemplary data flow for certificate issuance and party verification in accordance with a distributed authority system in accordance with the present disclosure.

FIG. 4 is a schematic block diagram illustrating an exemplary data flow for certificate issuance and vendor content security in accordance with the present disclosure.

FIG. 5 is a flow chart of an exemplary process for accessing software applications or content in accordance with the present disclosure.

FIG. 6 is a schematic diagram of an exemplary software architecture in accordance with the present disclosure.

FIG. 7 is a perspective view of point-of-service device in accordance with the present disclosure.

FIG. 8 is a perspective view of a set-top box device in accordance with the present disclosure.

FIG. 9 is a perspective view of a plurality of mobile devices and communications network in accordance with the present disclosure.

### DETAILED DESCRIPTION OF THE PREFERRED EMBODIMENT

The present disclosure overcomes the aforementioned drawbacks by providing a system and method for distributed validation and/or verification of parties and software content or devices deployed and/or connected to a communications network. For example, the present disclosure may be used to implement systems and methods for secure and trusted deployment of software. More particularly, the present disclosure provides a system and method that distributes the authority to create and disseminate software for devices between multiple parties. As will be described, this system and method presents a set of checks and balances between the parties involved with software deployment to ensure that a given piece of software is trusted, secure, verified, and the like.

In one implementation, the present invention is a system for verifying content distributed by a distributed authority system over a communications network. The system includes a storage device having stored thereon at least one certificate, and a network communications device coupled to a communications network. The system includes a processor configured to access instructions stored on a non-transitive storage medium that cause the processor to, a) request software content from a distribution center communicatively coupled to the communications network, and b) receive a package from the distribution center over the network communications device. The package includes at least a manifest and the software content. The processor is configured to c) access the at least one certificate and analyze the package to verify a chain of certificates associated with the package back to an intermediary root certificate, d) analyze at least one of the manifest and the software content to verify the package as corresponding to the software content requested from the distribution center, and e) if one of step c) and step d) fail to verify, discontinue processing of the software package, else permit access to the software content.

In another implementation, the present invention is a distributed authority system for distributing verifiable content over a communications network. The system includes an approver having oversight over an operational environment, an issuer operating at least a portion of a communications network connecting the approver and issuer and issuing an approver certificate based on an issuer intermediary root certificate after the approver passes verification with the issuer, and an assessor connected to the communications network and having authority to assess software content deployed into the operational environment represented by a assessor certificate issued by the issuer based on the issuer intermediary root certificate after the assessor passed certification with the approver and was verified by the issuer. The system includes a vendor connected to the communications network. The vendor performs the steps of requesting approval of software content by sending a copy of the software content to the assessor, receiving a signed copy of the software content from the assessor along with the assessor certificate, and receiving a signed manifest of the software content from the approver along with the approver certificate. The vendor performs the steps of bundling the signed copy of the software content and the signed manifest to form a software package, and making the software package available to devices coupled to the communications network and within the operational environment as a source and content verifiable software package.

In another implementation, the present invention is a method for verifying content distributed by a distributed authority system over a communications network. The method includes a) requesting software content from a distribution center communicatively coupled to the communications network, and b) receiving a package from the distribution center using a network communications device. The package includes at least a manifest and the software content. The method includes c) accessing at least one certificate to analyze the package to verify a chain of certificates associated with the package back to an intermediary root certificate, d) analyzing at least one of the manifest and the software content to verify the package as corresponding to the software content requested from the distribution center, and e) if one of step c) and step d) fail to verify, discontinuing processing of the software package, else permitting access to the software content.

In another implementation, the present invention is a method for a distributed authority system to distribute verifiable content over a communications network. The method includes requesting approval of software content by sending a copy of the software content to an assessor, the assessor having authority to assess software content deployed into an operational environment represented by an assessor certificate issued by an issuer based on an issuer intermediary root certificate after the assessor passed certification with an approver and was verified by the issuer. The approver has an approver certificate issued by the issuer and based on the issuer intermediary root certificate. The method includes receiving a signed copy of the software content from the assessor along with the assessor certificate, and receiving a signed manifest of the software content from the approver along with the approver certificate. The method includes bundling the signed copy of the software content and the signed manifest to form a software package, and making the software package available to devices coupled to the communications network and within the operational environment.

The present disclosure provides a system and method whereby a trusted party can “sign” software or content, such as applications, on behalf of another party, such as a manufacturer, repair store, and the like. As will be described, the system and method inhibits a party's ability to run malicious code on a user's device, where that code has not been signed by a trusted party.

The signing of code involves a cryptographic routine executed on the source code. The cryptographic routine, once executed, generates a hash or digital file that is both associated with the source code and can only be generated by the person initiating the cryptographic routine (i.e., the signer). That hash or digital file can then be distributed along with the source code. The hash or digital file can then be used by recipients of the source code to verify the identity of a person or entity that signed the source code. The tools used to generate these digital signatures are widely available. Accordingly, any entity (person or business) can generate signatures for source code.

Having signed code demonstrates no more than the fact that someone (anybody) has signed the code. In the case of self-signed certificates, the developer has signed the code. The recipient of the source code must then make the determination of whether the developer is a trusted party. However, the developer is often unknown to the code recipient and, consequently, that determination cannot be made intelligently. Unlike the case of self-signed certificates, therefore, the present disclosure provides a system and method for rigorous validation by a number of trusted third parties before source code is signed by those trusted third parties and forwarded to a target device and user.

The present disclosure is not limited to a particular industry or device. For example, the devices may be mobile phones, game consoles, televisions, general-purpose computers, mobile computing devices, payment devices, and the like. As described, all of these devices reflect the increasing trends of connecting devices to a communications network and allowing the software on the devices to be selected or updated with ease by an end user.

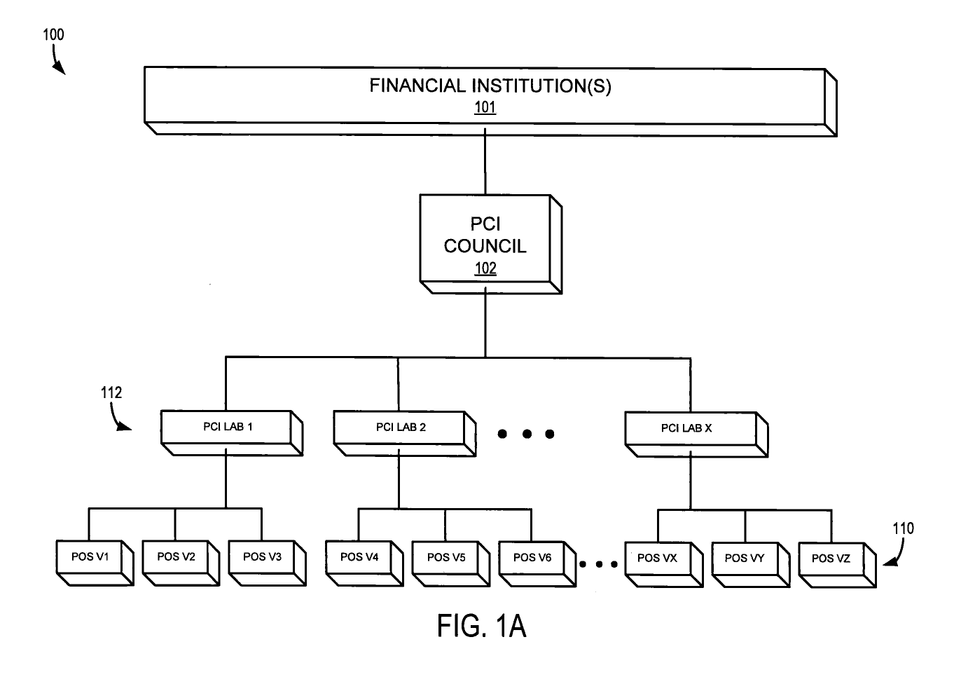

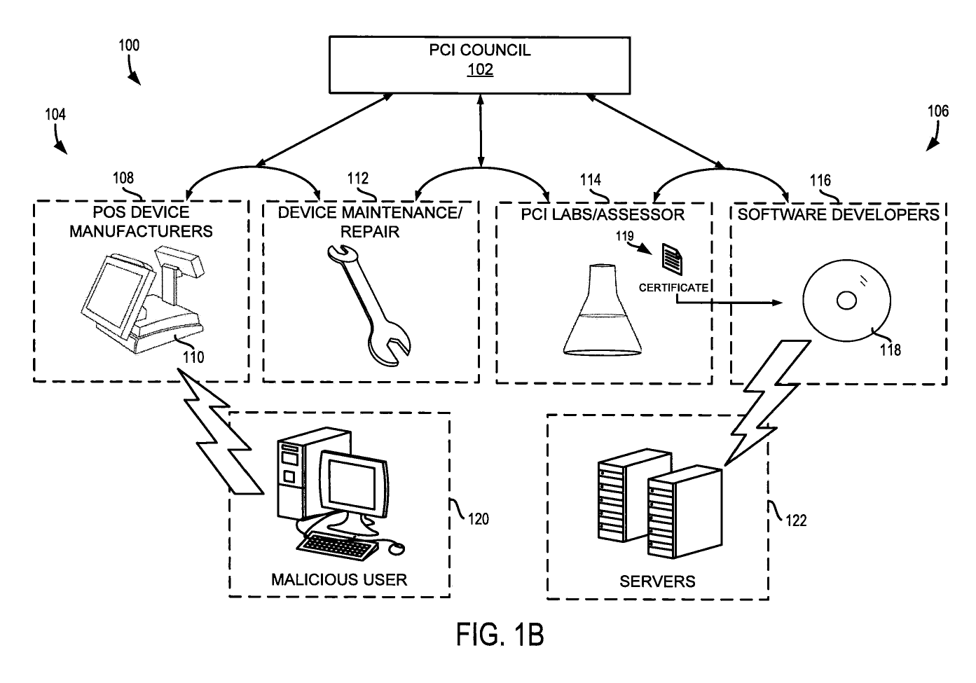

However, while the present invention is not limited to a particular device type, industry, communications network design, or the like, for exemplary purposes, the following, non-limiting example, of devices used in the payment card industry (PCI) will be provided. Referring to FIGS. 1A and 1B, an example payment card industry environment 100 is illustrated that can be conceptualized as a general hierarchy with one or more financial institutions 101 at the top. Within the payment card industry there are standards that are set forth by a PCI council 102 that extend obligations to all manufactures 104 and software vendors 106 involved in the industry/environment 100. As illustrated, some parties may include the point of sale (POS) device manufacturers 108 that disseminate POS devices 110, maintenance/repair shops 112 for these POS devices 110 or other device, PCI labs/assessors 114, and software developers 116.

When a given manufacturer, say a POS device manufacturer 108, has developed a new POS device 110 or a software developer 116 has created new software 118 for a given device 110, the new device 110 or software 118 is assessed by the PCI labs 114 and then by the PCI council 102. However, often times, to make the approval process more efficient, the PCI council 102 may delegate its portion of such a review process to the PCI lab 114 to issue a certificate 119 on its behalf.

In some cases, the POS device manufacturer 108 or software developer 116 could potentially deploy code, via the new device 110 or software 118, without the code being assessed by an assessor/PCI lab 114. The complexity of tracking and properly verifying software 118 and devices 110 can become very complex, for example, as the number of potential labs 112 increases or the particular labs change and as the diversity of devices 110 or software versions running across the devices diversifies, such as illustrated in FIG. 1A.

Furthermore, a malicious user 120 could attempt to take over a given POS device 110 and load it with his/her own software. Unfortunately, from time to time, such efforts have been successfully used to capture credit card numbers from a given device 110 and to transmit information to unauthorized servers 122.

As will be explained, the present disclosure provides systems and methods to overcome these and other undesirable scenarios so that no one entity can bypass one another. By doing so, for example, in the event of a POS device has a known vulnerability, the malicious party cannot load unapproved software because the unapproved software will not have been signed by a trusted private key that chains to a certificate authority (CA) root.

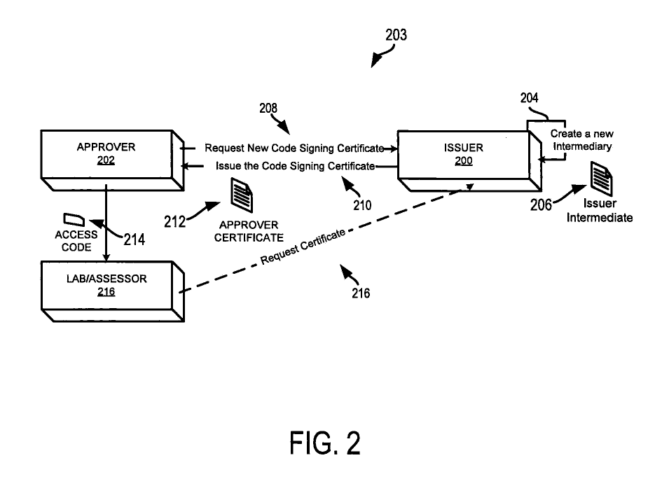

As described above the present disclosure is readily applicable to a variety of industries, applications, and environments. Thus, the exemplary environment 100 described above with respect to FIGS. 1A and 1B will be used as an exemplary environment of the generic and non-industry or environment-specific scenario that includes an “issuer” and “approver” relationship. Referring to FIG. 2, a data flow diagram is provided illustrating a first stage of data flows between an issuer 200 and an approver 202. In the preceding example environment of FIGS. 1A and 1B, the PCI council 102 may represent one example of an approver 202. The issuer 200 may be an entity that, within a communications network 203, is in a position to hold and issue certificates. For example, the issuer 200 may be a domain registrar or other Internet services or network infrastructure entity. Notably, in some industries or environments, the issuer 200 and approver 202 may be merged together as a single entity. Regardless of the particular configuration or entities implementing the system, the present disclosure provides a separation of powers through distributed responsibilities that create a set of checks and balances against erroneous or fraudulent deployment of devices or software.

With respect to the data flow illustrated in FIG. 2, at step 204, a new intermediary certificate 206 is created by the issuer 200 from a trusted root certificate held by the issuer 200, for example, that may be unique to a particular industry. In this example, the new intermediary certificate 206 may be called issuer intermediary certificate 206, which is a private key corresponding to this certificate. It is stored in a secure location.

At step 208, the approver 202 requests a new code signing certificate and this intermediary certificate 206 may be distributed in response to that request. For example, distribution may occur in a manner similar to how a regular intermediary certificate is distributed to all browsers.

At step 210, the private key of the intermediary certificate 206 is used by the issuer 200 to generate a new certificate for the requester after through validation of the request. The issuer 200 issues the first certificate to the approver 202, illustrated as approver certificate 212, and the approver certificate 212 is chained to the issuer intermediary certificate 206.

Within this construct, as new participants sign up and/or pass the examination with the approver 202, they request for their own certificate through the above-described process. This could be often done in one of multiple fashions. For example, the approver 202 may request the certificate on behalf of the new participant or the approver 202 may give an access code 214 to a lab/assessor 216 who passed the certification. As another alternative, the labs/assessor 216 directly requests 216 the certificate from the issuer 200 and the issuer 200 validates with the approver 202 that the labs/assessor 216 has, depending upon industry or system requirements, passed the certification, signed up for a partnership, established as an authorized reseller, and the like and, thereby, can be trusted to issue a certificate based upon the same issuer intermediary certificate 206.

The above-described operational data flow can be employed within the PCI environment described above with respect to FIGS. 1A and 1B. In other environments, for examples not pertaining to the PCI environment, the organization that is requesting the certificate can be validated and the certificate can be chained to the intermediary tied to that industry. Such a construct can be employed in the mobile device industry using, for example, mobile application certificates that are tied to the intermediary that is the platform provider for the module device, such as GOOGLE ANDROID, APPLE iOS, BLACKBERRY OS, and the like. As another example, satellite and cable receivers have a similar construct, whereby the satellite or cable service providers, or their designees, may act as the issuer 200.

Unfortunately, while the above-described operational data flow can be employed within various industries as a fast and distributed system and method for approving software for distribution into a given platform or industry, the operational protocol may be co-opted or corrupted and permit the distribution of flawed, fraudulent, or malicious software. In the PCI industry, such fraudulent or malicious software can misappropriate financial information of a user. In the mobile device industry, fraudulent or malicious software can be used to misappropriate identity information, circumvent carrier policies, and the like. In the content delivery industries, such as satellite or cable television industries, or the gaming industries, users can install applications on cable or satellite set-top devices or gaming consoles that may bypass the safety checks/subscriptions checks and facilitate free access to content.

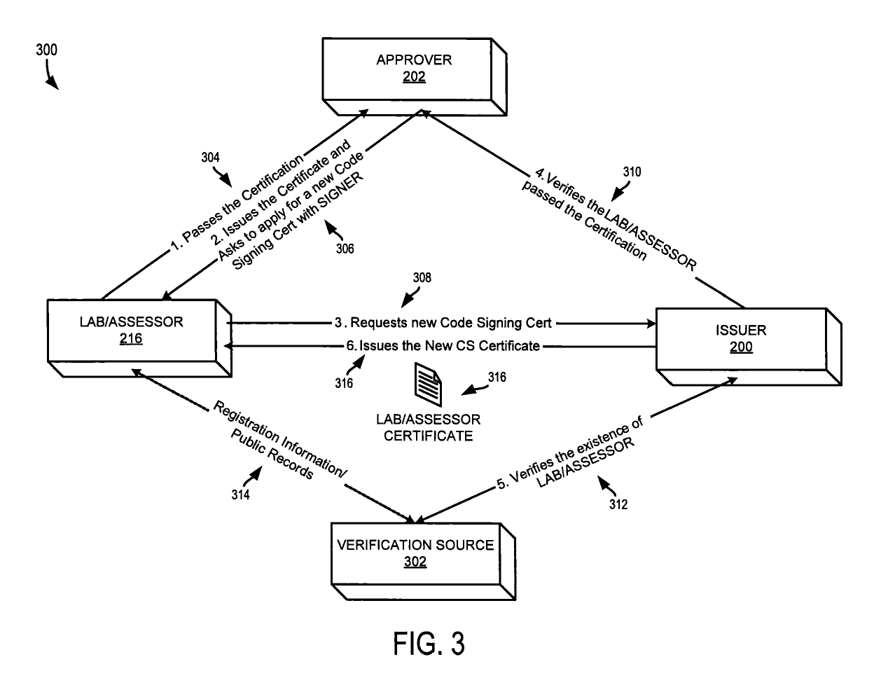

However, referring to FIG. 3, the present disclosure provides a system and method for controlling against such undesired or impermissible circumstances. In particular, a distributed authority environment 300 is illustrated that includes the issuer 200, approver 202, and lab/assessor 216, of FIG. 2, and also adds a verification source 302.

In the example provided in FIG. 3, the construction of this environment begins at data flow step 304 with the passing of certification from the lab/assessor 216 to the approver 202. That is, for purposes of this example, the process starts with the passing of certification from the lab/assessor 216 to the approver 202. Of course, it is possible that certification may not pass and, if so, the following process would be preempted. However, assuming that the lab/assessor 216 passes certification and the process can continue, responsive thereto, at step 306, the approver 202 issues the certificate and asks to apply for a new code signing certificate with the issuer 200. At step 308, the lab/assessor 216 requests the new code signing certificate from the issuer 200 and, at step 310, the issuer 200 verifies that the lab/assessor 216 previously passed the certification to the approver 202. Associated therewith, at step 312, the issuer 200 and verification source 302 communicate to verify the existence of the lab/assessor 216. The verification source 302 facilitates this process by leveraging registration information from the lab/assessor and/or public records information 314. This information gathered by the verification source 302 about the lab/assessor 216 is reconciled against information about the lab/assessor 216 available to the issuer 200. Thus, the verification source 203 provides a check against fraudulent identities or misrepresentation of an entity as an appropriate lab/assessor 216.

As exemplified by these initial steps, the environment 300 illustrated in FIG. 3 provides a balanced set of responsibilities between parties to enact checks and balances that yield verifiable security when deploying software or a new device including such software. As a further example, at step 316, consider the issuance of a new certificate to the labs/assessor 216, such as following the above-described validation. This new certificate can be created as a lab/assessor certificate 316 that is chained to the intermediary created, for example, such as described with respect to FIG. 2.

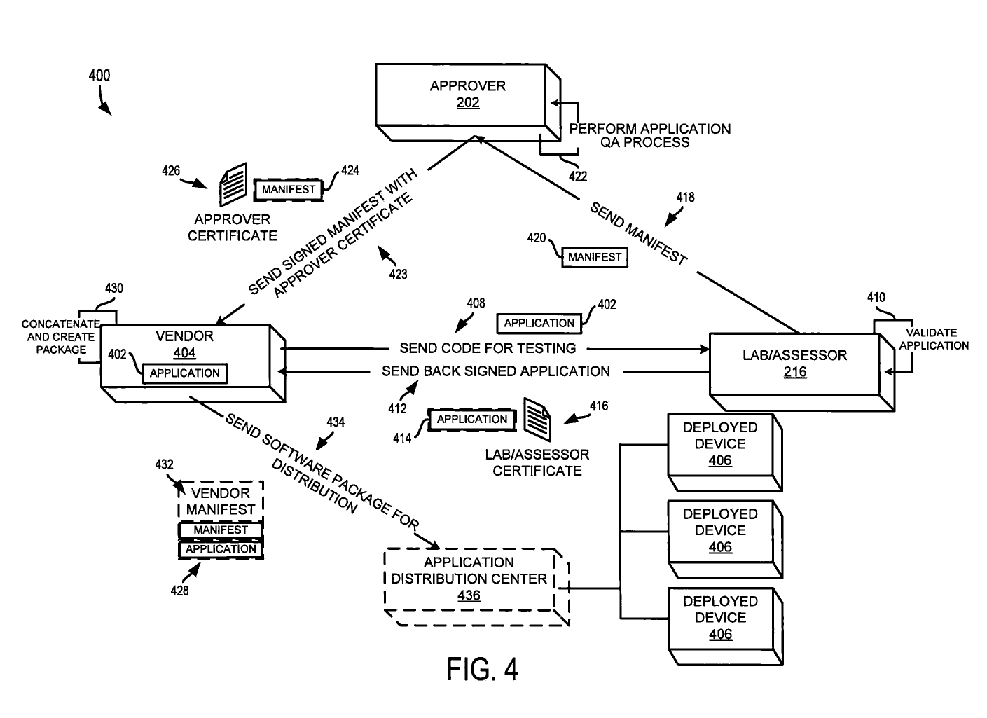

Referring now to FIG. 4, having, for example, completed the initial steps described above, an operational environment 400 for deploying content, for example, a software application 402, created by a vendor 404 into a market including deployed devices 406 is illustrated. As used herein, software content may refer to any general content that can be communicated over a communications network, such as movies, books, music, applications, apps, or any other content or information. As follows, the present example system will be described with respect to the distribution of a software application, however, such description is not by way of limitation and can extend to any content. The software application 402 may represent new software for an existing, deployed device 406 or an update for an existing, deployed device 406, or the software application 402 may be software designed to be deployed along with a new device. For exemplary purposes, the following description will address the deployment of the software application 402 to an existing, deployed device 406; however, the process is substantially similar if the software application 402 is coupled with a new device being sold or otherwise deployed into the environment 400.

As described above, the initial processes for verifying the lab/assessor 216 and its relationship to the approver 202 has been completed and, now, the vendor 404 is seeking the ability to deploy the software application 402 into the environment 400. To do so, at step 408 the vendor 404 sends the application 402, particularly, the code for the application 402, to the lab/assessor 216. As previously described, the lab/assessor 216 has been verified and, thus, at step 410, has the authority to validate applications for deployment into the environment 400. The validation step may include a variety of sub-steps, such as application testing to verify the performance of the application against specification, testing to ensure that the application does not provide functionality that is restricted in the environment 400, and various other testing protocols, such as specified by the approver 202 or another party or as agreed to by the members of the environment 400.

When the vetting process is complete, the lab/assessor 216 signs the application 402 with its private key (note, the private key may correspond to the public key in the lab/assessor certificate 316) and sends the encrypted/signed package to the vendor 404. That is, once the application 402 has been validated at step 410, at step 412, the lab/assessor 216 sends back a signed copy of the application 414, as indicated by the dashed encapsulation of the application 414 representing the signed application 414 accompanied by the lab/assessor certificate 416, for example, as derived through the process described with respect to FIG. 3. This process restricts the vendor 404 from adding any additional code or changing the code of the application 402 after it was validated at step 410.

At step 418, the lab/assessor 216 generates the hash of the application 402 before returning the signed application 414, and generating another hash after it has been signed. These values are entered into a manifest 420, and sent to the approver 202. At step 422, the approver 202 performs an application quality assurance (QA) process based on the received manifest 420. Assuming the QA process is passed, the approver 202 signs the manifest 418 with its own private key and sends a signed manifest 424 to the vendor 404 in step 423. Thus, the approver 202 sends back a signed copy of the manifest 424, as indicated by the dashed encapsulation of the manifest 424 representing the signed application 424 accompanied by the approver certificate 426, for example, as derived through the process described with respect to FIG. 2 (for example, the private key may corresponds to the public key in the certificate approver certificate 216).

Now that the vendor 404 has both the signed manifest 424 and the signed application 414, the vendor 404 creates a package 428 for distribution. This package 428 can be referred to, generally, as a content package or, in the case of distributing an application as described thus far, an application or software package. For example, at step 430, the vendor 424 can concatenate signed manifest 424 and the signed application 414. The vendor 404 can then generate a hash of the concatenated signed manifest/signed application and add it to a vendor manifest. Additionally, the vendor 404 may sign this concatenated blobs along with a specific vendor manifest 432. Doing so adds a further layer of security because the vendor 404 should be able to verify in the future that a given piece of code that is running on a particular device is the vendor's code.

Regardless of the particular implementation of creating the package 428, the vendor 404, at step 434, sends the software package 428 to an application distribution center 436. As indicated, the application distribution center 436 may be a separate entity or, in some environments or under some circumstances, the application distribution center 436 may be run by, for example, the vendor 404 or the approver 202 or another entity. In any case, through the application distribution center 436, the software package 428 is made available to the deployed devices 406.

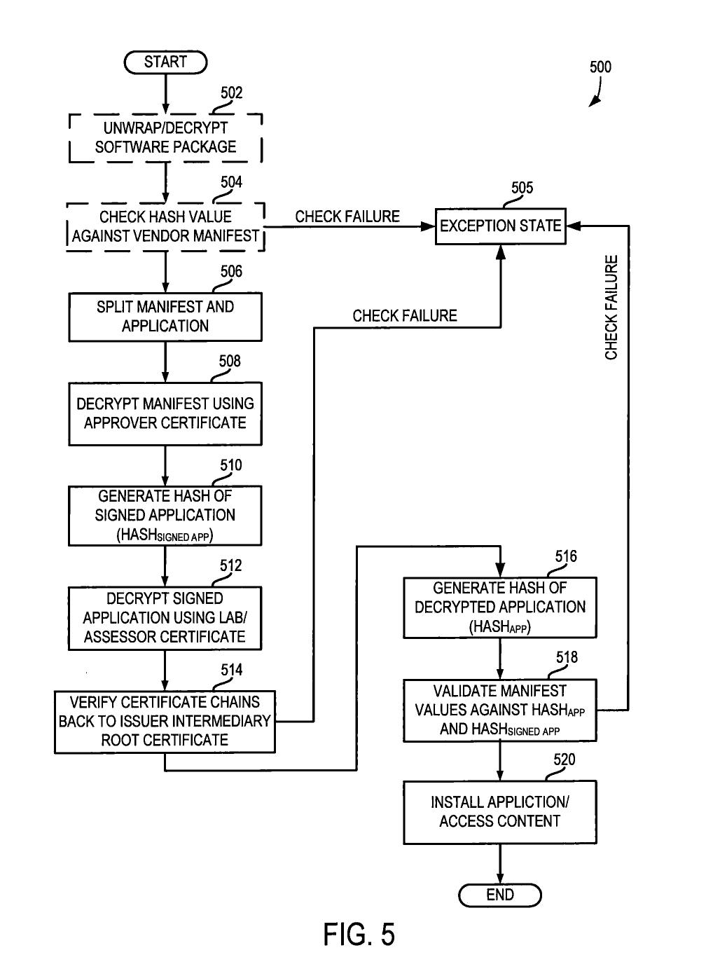

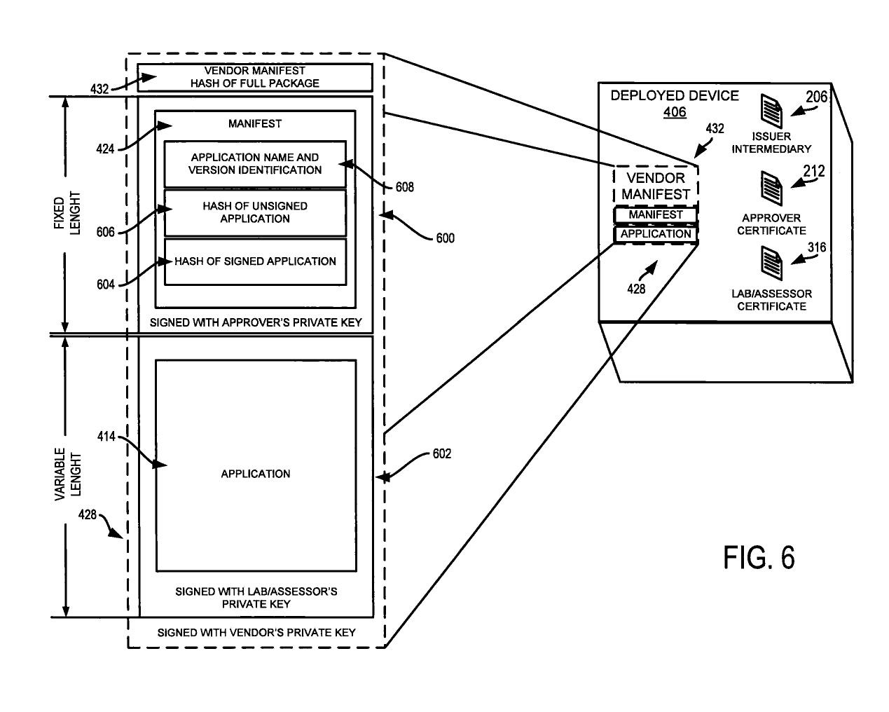

With the application available to a deployed device, referring to FIG. 5, a validation process may be followed before the application is executed or installed on a given deployed device. An example of a validation process 500 begins by unwrapping and/or decrypting the software package that was received by the deployed device at process block 502. For example, referring to FIG. 6, an example of the deployed device 406 having a downloaded software package 428 is illustrated. As described above, the vendor has the option of encrypting the software package 428 with a vendor manifest (and hash of the full package including the vendor manifest) using the vendor's private key. In this case, the deployed device 406 may unwrap and/or decrypt the (optionally) concatenated signed blob from the vendor that includes the vendor manifest. In this case, at process block 504, the deployed device 406 checks the hash value of the full package against the vendor manifest 432.

If the check at process block 504 fails, the process moves to an exception state at process block 505. An exception state can, depending upon the check failure that gave rise to the exception state and/or the type of deployed device and/or industry and/or vendor, approver, issuer rules, and the like, give rise to a variety of steps following thereafter. For example, if the exception state is indicative of a corrupted file, a simple notice of a corrupted file and a prompt to re-download the software package may be delivered to the user through the deployed device 406. On the other hand, if the exception state 505 is indicative of a potential attempt at a security breach or fraudulent activity, an alert to the user via the deployed device and/or an alert to the vendor, approver, or issuer may be issued. In some instances, the deployed device may even be disabled to protect against further exception states.

Returning to FIG. 5, assuming the optional check of the hash value against the vendor manifest passes or is not performed at process block 504, the process 500 continues at process block 506 by splitting the manifest 424 and application 414. Specifically, the deployed device 406 splits the concatenated blob into two halves 600, 602. As indicated, the first half 600 that includes the manifest 424 is signed by the approver and is a fixed length. The second half 602 includes the application 414 and may be a variable length.

With respect to the first half 600, at process block 508, the deployed device 406 decrypts the encrypted manifest 424 using the approver's public key, which is present in the approver's certificate 212, to extract the hash values for both the signed application 604, the unsigned application 606, and the application name and version identification 608. Thereafter, at process block 510, the deployed device 406 generates a hash of the signed application from the second part of the blob.

At process block 512, the deployed device 406 decrypts the second half using the public key present in the lab/assessor certificate 316. At process block 514, the deployed device 406 verifies the certificate chains back to the issuer's intermediary root certificate 206. In this regard, the integrity of the software package 428 and, more to the point, the identities of the parties to the process that created the software package 428 is checked all the way back to the earliest steps of the issuer's intermediary certificate 206. Again, if this check fails, an exception state is reached at process block 505. The exception state may result in any of a variety of actions following thereafter that may depend, for example, upon the type of deployed device, the industry of the deployed device, the policies of the vendor, assessor, approver, and/or issuer, or other considerations.

If the check at process block 514 is passed, at process block 516, the deployed device 406 generates a hash of the decrypted application and, then, at process block 518, compares the hashes of both the encrypted and the decrypted application against the hash value in the manifest file. This check verifies that the application 414, itself, in addition to the process above that verified the identities of the parties to the process creating the software package 424, is consistent. Again, if this check fails, the exception state is reached at process block 505 and can be handled by any of the various methods described above or the like. However, once this check at process block 518 is passed, at process block 520, the application is installed or the content accessed.

By following the above processes or similar processes, online certificate status protocol (OCSP)/certificate revocation list (CRL) lists can be created that show the certificates that have been created and/or revoked. In the event that a key has been compromised, a CRL command can be immediately be issued for that certificate. In such an instance, when a device with the revoked certificate checks in, all parties to the system can know the certificate is compromised and can, for example, enter a lockdown state or not process further transactions. In some cases, the devices are configured to routinely check in to ensure that a CRL command has not been issued for the certificate. If, for some reason, the device is unable to check in (e.g., because the device has been taken off the network or its communication capabilities have otherwise been disabled or interfered with), the device may be configured to automatically cease functioning or otherwise disable the code.

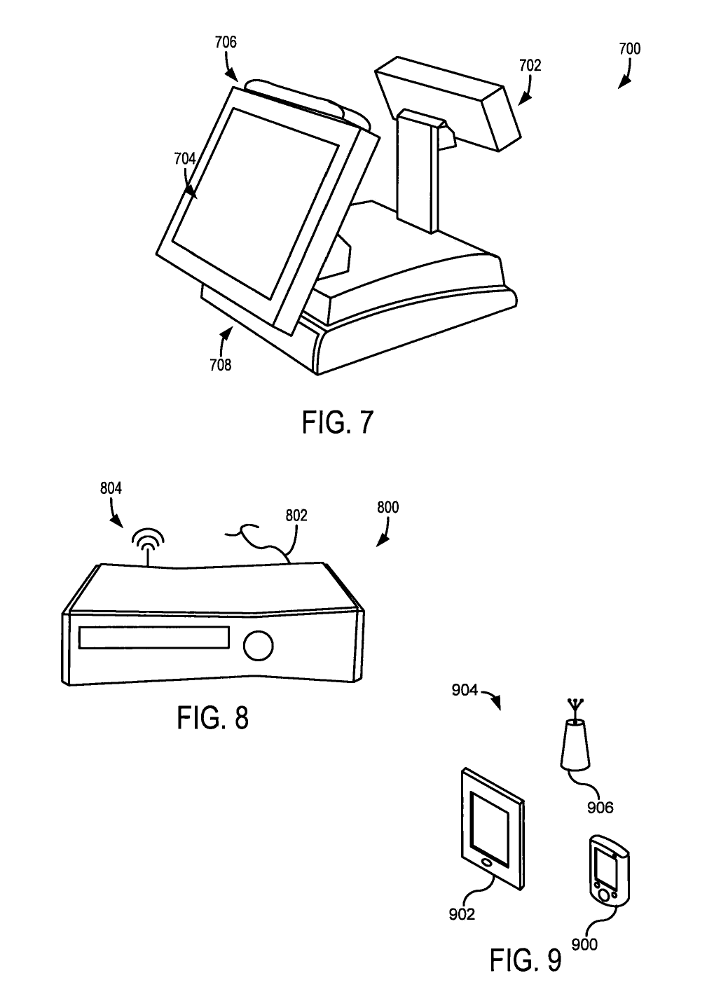

As described above, the systems and methods of the present disclosure may be used with a wide variety of deployed devices and communications networks or other systems. For example, reference was made above to the payment card industry and POS devices. Referring to FIG. 7, a POS device 700 is illustrated. A POS device 700 may be installed at a point of retail service such as to facilitate shopping or informational services. Such POS devices may include user interfaces that may include passive displays 702 or active displays 704 to communicate with operators of the POS device 700 and/or consumers. The active display 704 may be configured to present a variety of information and facilitate interaction, such as by presenting virtual buttons and keyboards and other user interface components. Of course, a dedicated keyboard (not shown) may also be used. The POS device 700 may also include a magnetic strip reader 706, such as to read magnetic strips typically employed with credit or debit or other payment cards. Additionally or alternatively, the POS device 700 may include a near-field communications (NFC) interface or other wireless communications interface to receive payment and/or communicate with a communications network coupled thereto. Furthermore, the POS device 700 may include a cash drawer 708 and other components for facilitating financial transactions.

Referring to FIG. 8, another example of a deployed device is illustrated, which is embodied as a so-called, “set-top” box 800. The set-top box may be a cable or satellite set-top box, a game console, an internet content access system, or the like. It is coupled to a communications network via a wired connection 802 or wireless network connection 804. The set-top box 800 may serve as a deployed device, such as described above with respect to FIGS. 1-6 and the process of delivering application software be tailored for the set-top box 800. For example, the set-top box 800 may be configured to receive new software, operating system or application software, or may be configured to receive content, such as games, movies, or the like, using the above-described systems and methods.

Referring to FIG. 9, another example of a deployed device is illustrated, which is represented as a mobile device, such as a phone 900 or tablet 902. Of course, the illustrated phone 900 and tablet 902 are but a few of the many mobile devices, including other general mobile computing or communications devices. Such devices are often configured to communicate within a wireless communications environment 904 that includes wireless communications station 906. The wireless communications station 906 may be a local area network wireless communications station or a wide or very-wide area network wireless communications station, such as a cellular or other network communications system. the mobile devices 900, 902 may be configured to receive new software, operating system or application software, or may be configured to receive content, such as games, movies, or the like, using the above-described systems and methods.

The present invention has been described in terms of one or more preferred embodiments, and it should be appreciated that many equivalents, alternatives, variations, and modifications, aside from those expressly stated, are possible and within the scope of the invention.

1. A method for verifying content distributed by a distributed authority system over a communications network, comprising:
a) requesting software content from a distribution center communicatively coupled to the communications network;
b) receiving a package from the distribution center using a network communications device, the package including at least a manifest and the software content;
c) accessing at least one certificate to analyze the package to verify a chain of certificates associated with the package back to an intermediary root certificate;
d) analyzing at least one of the manifest and the software content to verify the package as corresponding to the software content requested from the distribution center; and
e) if one of step c) and step d) fail to verify, discontinuing processing of the software package, else permitting access to the software content.

2. The method of claim 1, wherein the software content includes a firmware update for second instructions stored on a non-transitive storage medium.

3. The method of claim 1, wherein the software content includes at least one of media and a computer program.

4. The method of claim 3, wherein the software content includes a signed copy of the at least one of the media and the computer program.

5. The method of claim 1, wherein the manifest and the software content are signed by separate parties.

6. The method of claim 1, including, when one of step c) and step d) fail to verify, outputting a warning to a user using a user interface device.

7. The method of claim 6, wherein outputting a warning to a user includes transmitting an alert message to a vendor of the software content.

8. The method of claim 6, including prompting a user to re-request the software content from the distribution center.

9. The method of claim 1, wherein the software content is configured to be executed by at least one of a point-of-sale device, a set-top box, and a mobile device.

10. A method for a distributed authority system to distribute verifiable content over a communications network, comprising:
requesting approval of software content by sending a copy of the software content to an assessor, the assessor having authority to assess software content deployed into an operational environment represented by an assessor certificate issued by an issuer based on an issuer intermediary root certificate after the assessor passed certification with an approver and was verified by the issuer, the approver having an approver certificate issued by the issuer and based on the issuer intermediary root certificate;
receiving a signed copy of the software content from the assessor along with the assessor certificate;
receiving a signed manifest of the software content from the approver along with the approver certificate;
bundling the signed copy of the software content and the signed manifest to form a software package; and
making the software package available to devices coupled to the communications network and within the operational environment.

11. The method of claim 10, wherein the software content includes a firmware update for the devices.

12. The method of claim 10, wherein the software content includes at least one of media and a computer program.

13. The method of claim 12, wherein the software content includes a signed copy of the at least one of the media and the computer program.

14. The method of claim 10, wherein an identity of the assessor is reviewed by a verification source to verify an identity of the assessor.

15. The method of claim 10, wherein the devices include at least one of a point-of-sale device, a set-top box, and a mobile device.

16. The method of claim 10, including signing at least a portion of the software package.

17. The method of claim 16, wherein signing at least a portion of the software package includes creating a vendor manifest.

18. The method of claim 10, including receiving a warning when verification of the software package fails on a device.

19. The method of claim 18, wherein, when verification of the software package fails on a device due to a potential security breach or a fraudulent activity, the warning includes a notification of the potential security breach or the fraudulent activity.

20. The method of claim 10, wherein making the software package available to devices coupled to the communications network includes transmitting the software package to a software distribution center.
